(19) United States
(12) Patent Application Publication
(10) Pub. No.: US 2013/0229629 A1
(43) Pub. Date: Sep. 5, 2013

(54) MULTI-SCREEN DISPLAY DEVICE

(71) Applicant: Naoki KAWAMOTO, Tokyo (JP)

(72) Inventor: Naoki KAWAMOTO, Tokyo (JP)

(73) Assignee: Mitsubishi Electric Corporation, Tokyo (JP)

(21) Appl. No.: 13/721,175

(22) Filed: Dec. 20, 2012

(30) Foreign Application Priority Data
Mar. 2, 2012 (JP) 2012-046190

(51) Int. Cl. H04N 9/31

(52) U.S. Cl. CPC H04N 9/31
USPC 353/30

(57) ABSTRACT

A multi-screen display device according to the present invention is a multi-screen display device in which screens of a plurality of projectors are combined to form one screen. Each of the projectors includes a light source, an illumination optical system that irradiates the light output from the light source as illumination light, a light modulator that modulates the illumination light and forms image light, and a projection optical system that projects the image light onto a screen. The multi-screen display device includes at least one spectral sensor that detects changes in brightness and chromaticity of the image light in each of the projectors.

### BACKGROUND OF THE INVENTION

1. Field of the Invention

The present invention relates to a multi-screen display device, and more particularly, to a multi-screen display device in which screens of a plurality of projectors are combined to form one screen.

2. Description of the Background Art

A multi-screen display device is known as the device that forms a large screen through the combination of screens of a plurality of projectors.

In a conventional multi-screen display device, in order to correct a difference in brightness or a difference in chromaticity between screens, a brightness sensor or a color sensor is used as an optical sensor, and an output of a video signal is adjusted in accordance with a change in brightness of a single color such as red, green, or blue, to thereby adjust white.

As the conventional technology of correcting the brightness and chromaticity of a projector, Japanese Patent Application Laid-Open No. 2003-323610 discloses the technology of detecting the reflected light of an image projected onto a screen by a color sensor connected to the outside of the projector, to thereby correct brightness and chromaticity.

In the technology described in Japanese Patent Application Laid-Open No. 2008-89836, optical sensors are provided to cover a projection lens of a projector, to thereby measure and correct the brightness of the light projected onto the projector.

Nowadays, solid-state light sources such as LEDs and lasers are used as light sources in projectors. As to those solid-state light sources, unfortunately, even in a light source of a single color such as red, green, or blue, a wavelength of an output light beam changes due to use environment or deterioration in terms of device characteristics, which causes a change not only in brightness but also in chromaticity.

Therefore, it is required to accurately measure a spectrum of the light output from each light source in a projector and correct brightness and chromaticity also in consideration of a change in wavelength of the light source.

According to Japanese Patent Application Laid-Open No. 2003-323610, while a color sensor detects brightness and chromaticity even in consideration of a wavelength as well, the color sensor is not included in the projector but is connected to the outside for use. Therefore, it is required to provide color sensors as many as screens to the outside for forming a multi-screen by this method, and thus, a burden on a user increases.

According to Japanese Patent Application Laid-Open No. 2008-89836, brightness is measured and corrected with the projection lens of the projector being covered with the color sensors, but a change in wavelength is not taken into consideration. In addition, brightness is measured with the projection lens being covered, and thus, the brightness cannot be corrected while a video image is being projected, which may be inconvenient for a user.

### SUMMARY OF THE INVENTION

An object of the present invention is to provide a multi-screen display device that includes an optical sensor detecting brightness and chromaticity and is capable of correcting a difference in brightness and a difference in chromaticity between screens in accordance with the detected brightness and chromaticity.

A multi-screen display device according to the present invention is a multi-screen display device in which screens of a plurality of projectors are combined to form one screen. Each of the projectors includes a light source, an illumination optical system that irradiates the light output from the light source as illumination light, a light modulator that modulates the illumination light and forms image light, and a projection optical system that projects the image light onto a screen. The multi-screen display device according to the present invention includes at least one spectral sensor that detects changes in brightness and chromaticity of the image light in each of the projectors.

According to the present invention, the optical spectrum is measured for each monochromatic light source with the spectral sensor, whereby the brightness and chromaticity of each light source can be detected with accuracy. Therefore, even if the wavelength of the monochromatic light source changes, it is possible to reduce a difference in brightness and a difference in chromaticity between screens by correcting the brightness and chromaticity of the image light. The spectral sensor is included in the multi-screen display device, which eliminates a burden on a user of, for example, installing a spectral sensor every time a correction is made. Accordingly, the operability is improved compared with a conventional case.

These and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 shows the configuration of a projector included in a multi-screen display device according to a first preferred embodiment;

FIG. 2 shows turn-on timings of light sources according to the first preferred embodiment;

FIG. 3 shows temperature dependencies of spectra of a red LED light source;

FIG. 4 shows temperature dependencies of luminous flux amount and luminous energy of the red LED light source;

FIG. 5 shows temperature dependencies of chromaticity of the red LED light source;

FIG. 6 shows color matching functions in an XYZ color system;

FIG. 7 shows chromaticity spaces of a first projector and a second projector;

FIG. 8 shows the configuration of a multi-screen display device according to a second preferred embodiment;

FIG. 9 shows an example of a shutter for switching optical fibers according to the second preferred embodiment;

FIG. 10 shows the configuration of a projector included in the multi-screen display device according to the second preferred embodiment;

FIG. 11 shows the configuration of a projector included in a multi-screen display device according to a third preferred embodiment;

FIG. 12 shows the configuration of a multi-screen display device according to a fourth preferred embodiment; and

FIG. 13 shows the configuration of a projector included in the multi-screen display device according to the fourth preferred embodiment.

### DESCRIPTION OF THE PREFERRED EMBODIMENTS

### First Preferred Embodiment

<Configuration>

A multi-screen display device according to this preferred embodiment includes two projectors (first projector and second projector), and the two screens are combined to form a large screen.

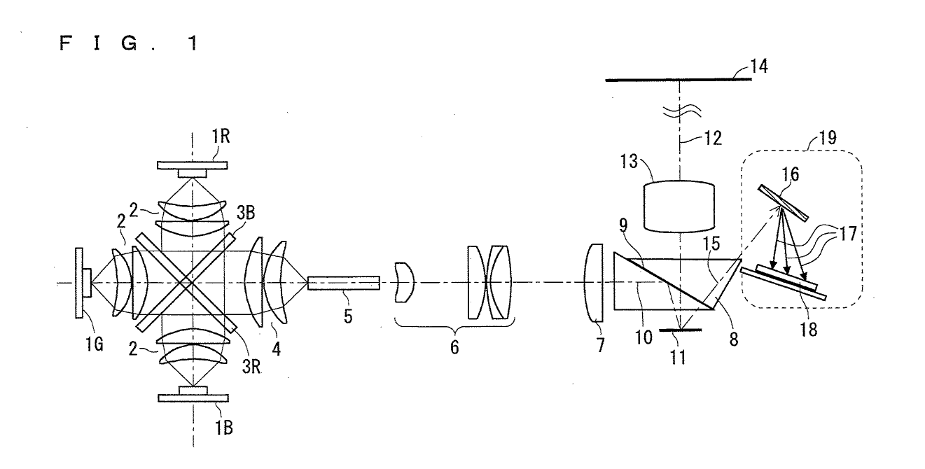

As shown in FIG. 1, the first projector includes a light source, an illumination optical system that irradiates the light emitted from the light source as illumination light, a total internal reflection prism 8 (also referred to as TIR prism) that deflects a path of the illumination light and causes the light to be incident on a light modulator, the light modulator that modulates the illumination light to form image light, a projection optical system 13 that projects the image light onto a screen, and a spectral sensor 19 that measures brightness and chromaticity. The configuration and operation of the second projector are similar to those of the first projector, and thus, only the configuration and operation of the first projector are described below.

Used as the light sources of the first projector are a red LED light source 1R that emits a red light beam, a green LED light source 1G that emits a green light beam, and a blue LED light source 1B that emits a blue light beam.

The color light beams emitted from the respective light sources are incident on the light modulator through the illumination optical system. The illumination optical system is composed of collimator lenses 2 that collimate the color light beams from the respective light sources, a dichroic mirror 3R that reflects the red light beam and allows the green and blue light beams to pass therethrough, a dichroic mirror 3B that reflects the blue light beam and allows the red and green light beams to pass therethrough, condensing lenses 4, an integrator 5, a relay lens group 6, and a field lens 7.

Used as the light modulator is a digital micromirror device (DMD) chip 11. The light modulator forms image light, and the image light as ON light 12 is projected onto a screen 14 through the projection optical system 13. A projection optical system 13 is formed of, for example, a projection lens.

OFF light 15 reflected toward the outside of the screen 14 by the DMD chip 11 enters the spectral sensor 19. The spectral sensor 19 is composed of a diffraction grating 16 that disperses the OFF light 15 and a line sensor 18 that detects dispersed light 17.

The operations of the projector and the spectral sensor 19 are described below. After being collimated by the collimator lenses 2, the color light beams emitted from the respective light sources are selectively allowed to pass through and be reflected on the dichroic mirrors 3R and 3B, and are guided in the same path, to thereby enter the condensing lenses 4.

The color light beams are condensed on the entrance surface of the integrator 5 through the condensing lenses 4 and have a uniform distribution of light on the exit surface of the integrator 5. The integrator 5 is formed of a glass rod, a four-surface-bonded mirror, or the like, and the captured light is diffused inside the integrator 5 to have a uniform distribution of light.

The color light beam whose distribution of light has been made uniform enters the total internal reflection prism 8 through the relay lens group 6 and the field lens 7. Illumination light 10 that has entered the total internal reflection prism 8 is reflected on a total internal reflection surface 9 of a prism to be incident on the DMD chip 11.

The DMD chip 11 changes an angle of a micromirror in response to a control signal and reflects the illumination light 10 thereon, to thereby switch from the illumination light 10 to the ON light 12 to be projected onto the screen 14 or the OFF light 15 away from the screen 14.

The ON light 12 is projected onto the screen 14 through the projection optical system 13 and forms an image on the screen 14. Also in the second projector, the ON light 12 is projected onto the screen 14, whereby one large screen is composed of screens of the two projectors.

Meanwhile, the OFF light 15 of the DMD chip 11 is provided to the spectral sensor 19, and is used for the corrections of the brightness and chromaticity between the screens, as described below.

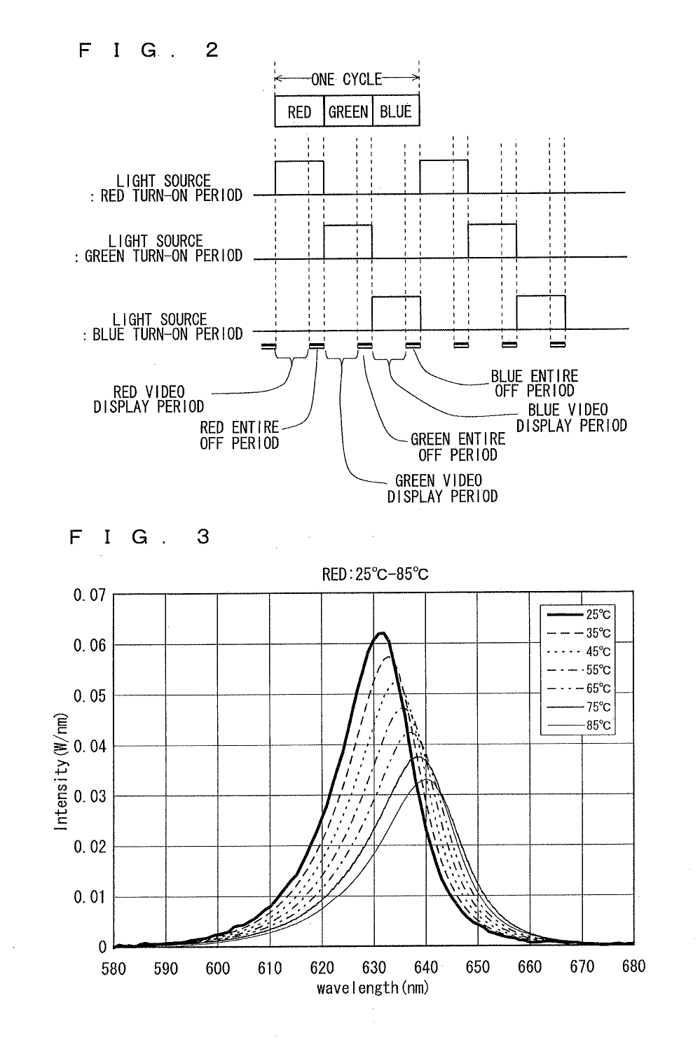

FIG. 2 shows turn-on timings of the respective light sources and the measurement timings of the spectral sensor 19. The light sources of red, green, and blue turn on in a time division manner. That is, the light sources are sequentially turned on in order, to thereby form image light corresponding to one frame rate (one cycle). The turn-on period of each light source is composed of a video display period and an entire OFF period. In the video display period, the ON light 12 and the OFF light 15 are switched by pulse width module (PWM) control, to thereby express the gradation of an image. The gradation is determined by a ratio between periods of time of the ON light 12 and the OFF light 15. For example, as shown in FIG. 2, in a case where the ON light 12 is output over the entire video display periods in the respective light sources, white light having the highest brightness is formed as the image light.

During the entire OFF period, the DMD chip 11 is switched to output the OFF light 15, and the color light beams are all provided to the spectral sensor 19.

The OFF light 15 provided to the spectral sensor 19 is incident on the diffraction grating 16. The OFF light 15 is dispersed owing to its nature that a diffraction direction differs per wavelength of the diffraction grating 16, and the dispersed light 17 is incident on the line sensor 18. The line sensor 18 is formed through the arrangement of, for example, 1,024 elements that output electric signals in accordance with the intensity of the incident light, and is capable of measuring the optical spectrum of the OFF light 15 using an output of the electric signal. The peak intensity of the optical spectrum of the OFF light 15 is in association with the brightness of a video image, that is, the brightnesses of the light source and the light beam that has passed through the illumination optical system.

Through the comparison between the obtained optical spectra of red light, green light, and blue light and the initially-obtained optical spectra of red light, green light, and blue light, change amounts of the brightness and chromaticity are obtained. In addition, the OFF light 15 of the DMD chip 11 is used for the measurement, so that optical spectra are obtained constantly in a normal video display state.

<Corrections of Brightness and Chromaticity>

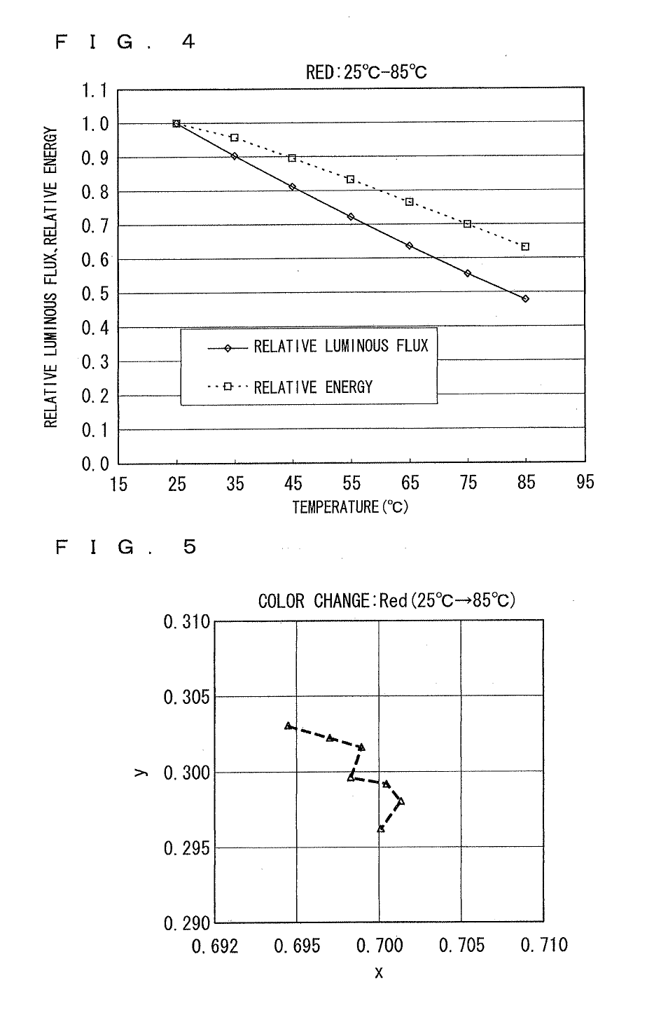

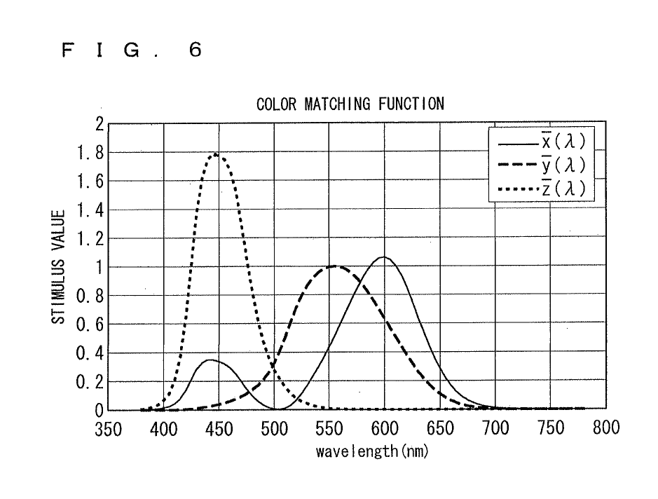

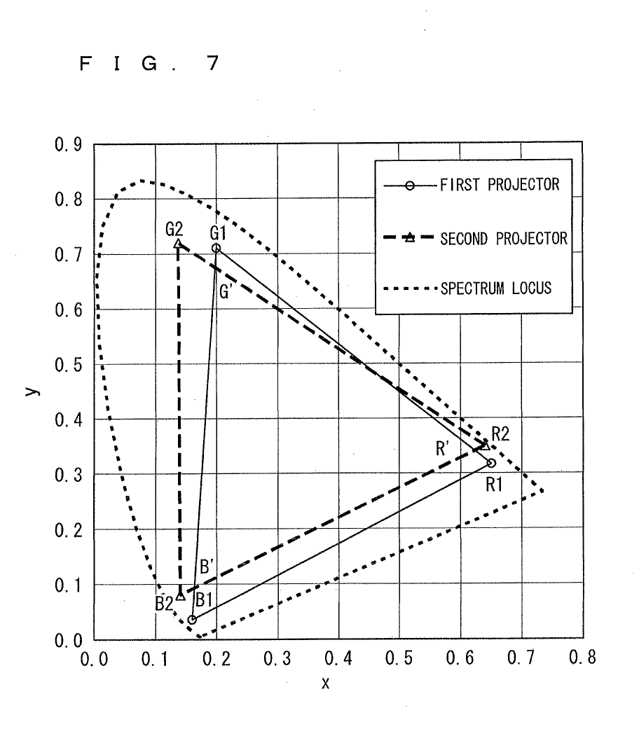

FIG. 3 shows optical spectra of the OFF light 15 of the red LED light source 1R that are measured with the spectral sensor 19. It is revealed that the peak wavelength and peak intensity of the optical spectrum vary in accordance with temperature changes (25° C. to 85° C.) of the red LED light source 1R. FIG. 4 shows relative values of the relative energy and luminous flux amount (Lumen value) corresponding to temperature changes of FIG. 3. The wavelength varies along with temperature changes, and accordingly, a degree of change differs between the luminous energy and luminous flux amount. FIG. 5 is a chromaticity diagram corresponding to FIG. 3, which reveals that the chromaticity of red light of the red LED light source 1R changes along with temperature changes.

As described above, the chromaticity of a light source varies between projectors along with, for example, changes in ambient temperature between projectors, leading to differences in brightness and chromaticity between the screens. The brightness and chromaticity are corrected such that tristimulus values (X, Y, Z), which are calculated based on optical spectra S_{R}(λ), S_{G}(λ), and S_{B}(λ) of the OFF light 15 of the respective light sources (red LED light source 1R, green LED light source 1G, and blue LED light source 1B) measured with the spectral sensor 19, are equal to each other between the screens.

For example, tristimulus values (X_{R}, Y_{R}, Z_{R}) corresponding to the optical spectrum S_{R}(λ) of the OFF light 15 of the red LED light source 1R are obtained by Expression (1). In Expression (1), x̅(λ), y̅(λ), and z̅(λ) represent color matching functions in the XYZ color system (see FIG. 6), and K represents a constant. Tristimulus values (X_{G}, Y_{G}, Z_{G}) corresponding to the OFF light 15 of the green LED light source 1G and tristimulus values (X_{B}, Y_{B}, Z_{B}) corresponding to the OFF light 15 of the blue LED light source 1B can be obtained by substituting S_{R}(λ) by S_{G}(λ) and S_{B}(λ), respectively, in Expression (1). Here, S_{G}(λ) and S_{B}(λ) are the optical spectra of the OFF light 15 in the green LED light source 1G and the blue LED light source 1B, respectively.

$$\begin{matrix}\begin{matrix}{X}_{R} = K {\int }_{380}^{780} {S}_{R} ( λ ) \cdot \overline{x} ( λ ) d λ \\ {Y}_{R} = K {\int }_{380}^{780} {S}_{R} ( λ ) \cdot \overline{y} ( λ ) d λ\end{matrix} \\ {Z}_{R} = K {\int }_{380}^{780} {S}_{R} ( λ ) \cdot \overline{z} ( λ ) d λ\end{matrix} \} \qquad ( 1 )$$

Generally, Y among the tristimulus values (X, Y, Z) represents brightness, and the chromaticity (x, y) is obtained with the tristimulus values by Expression (2).

$$\begin{matrix}x = X / ( X + Y + Z ) \\ y = Y / ( X + Y + Z )\end{matrix} \} \qquad ( 2 )$$

The method of correcting a difference in chromaticity between the two screens of the first projector and the second projector is described with reference to FIG. 7. In the chromaticity diagram of FIG. 7, an area with R₁, G₁, and B₁ as vertices, which is surrounded by a solid line, is a chromaticity space that can be created by the first projector, and an area with R₂, G₂, and B₂ as vertices, which is surrounded by a dashed line, is a chromaticity space that can be created by the second projector. Accordingly, the area with R′, G′, and B′ as vertices, which is common to those areas, is a chromaticity space that can be created by the first projector and the second projector. Therefore, it suffices that a difference in chromaticity is corrected such that the vertices of the chromaticity spaces of the two projectors coincide with the vertices (R′, G′, B′) of the common area.

Hereinbelow, as to the first projector, the tristimulus values corresponding to the OFF light 15 of the red LED light source 1R are denoted by X_{R1}, Y_{R1}, and Z_{R1}, the tristimulus values corresponding to the OFF light 15 of the green LED light source 1G are denoted by X_{G1}, Y_{G1}, and Z_{G1}, and the tristimulus values corresponding to the OFF light 15 of the blue LED light source 1B are denoted by X_{B1}, Y_{B1}, and Z_{B1}. The tristimulus values in the second projector are denoted by substituting subscript 1 of the tristimulus values in the first projector by subscript 2. The stimulus values after the correction are represented as ones obtained by adding an apostrophe to the stimulus values. For example, the tristimulus values before correction that correspond to the OFF light 15 of the red LED light source 1R of the first projector are denoted by X_{R1}, Y_{R1}, and Z_{R1}, and the tristimulus values after correction that correspond thereto are denoted by X′_{R1}, Y′_{R1}, and Z′_{R1}.

The relationship among the tristimulus values before and after correction in the first projector are represented by Expression (3). The tristimulus values before and after correction are associated with correction parameters (a, b, c, d, e, f, g, h, i).

$$\begin{matrix}\begin{matrix}[ \begin{matrix}\begin{matrix}{X}_{R 1}^{′} \\ {Y}_{R 1}^{′}\end{matrix} \\ {Z}_{R 1}^{′}\end{matrix} ] = a [ \begin{matrix}{X}_{R 1} \\ {Y}_{R 1} \\ {Z}_{R 1 }\end{matrix} ] + b [ \begin{matrix}{X}_{G 1} \\ {Y}_{G 1} \\ {Z}_{G 1}\end{matrix} ] + c [ \begin{matrix}{X}_{B 1} \\ {Y}_{B 1} \\ {Z}_{B 1}\end{matrix} ] \\ [ \begin{matrix}{X}_{G 1}^{′} \\ {Y}_{G 1}^{′} \\ {Z}_{G 1}^{′}\end{matrix} ] = d [ \begin{matrix}{X}_{R 1} \\ {Y}_{R 1} \\ {Z}_{R 1}\end{matrix} ] + e [ \begin{matrix}{X}_{G 1} \\ {Y}_{G 1} \\ {Z}_{G 1}\end{matrix} ] + f [ \begin{matrix}{X}_{B 1} \\ {Y}_{B 1} \\ {Z}_{B 1}\end{matrix} ]\end{matrix} \\ [ \begin{matrix}{X}_{B 1}^{′} \\ {Y}_{B 1}^{′} \\ {Z}_{B 1 }^{′}\end{matrix} ] = g [ \begin{matrix}{X}_{R 1} \\ {Y}_{R 1} \\ {Z}_{R 1}\end{matrix} ] + h [ \begin{matrix}{X}_{G 1} \\ {Y}_{G 1} \\ {Z}_{G 1}\end{matrix} ] + i [ \begin{matrix}{X}_{B 1} \\ {Y}_{B 1} \\ {Z}_{B 1}\end{matrix} ]\end{matrix} \} \qquad ( 3 )$$

Expression (4) is a relational expression of the tristimulus values before and after correction in the second projector. The tristimulus values before and after correction are associated with correction parameters (j, k, l, m, n, o, p, q, r).

$$\begin{matrix}\begin{matrix}[ \begin{matrix}\begin{matrix}{X}_{R 2}^{′} \\ {Y}_{R 2}^{′}\end{matrix} \\ {Z}_{R 2}^{′}\end{matrix} ] = j [ \begin{matrix}{X}_{R 2} \\ {Y}_{R 2} \\ {Z}_{R 2 }\end{matrix} ] + k [ \begin{matrix}{X}_{G 2} \\ {Y}_{G 2} \\ {Z}_{G 2}\end{matrix} ] + l [ \begin{matrix}{X}_{B 2} \\ {Y}_{B 2} \\ {Z}_{B 2}\end{matrix} ] \\ [ \begin{matrix}{X}_{G 2}^{′} \\ {Y}_{G 2}^{′} \\ {Z}_{G 2}^{′}\end{matrix} ] = m [ \begin{matrix}{X}_{R 2} \\ {Y}_{R 2} \\ {Z}_{R 2}\end{matrix} ] + n [ \begin{matrix}{X}_{G 2} \\ {Y}_{G 2} \\ {Z}_{G 2}\end{matrix} ] + o [ \begin{matrix}{X}_{B 2} \\ {Y}_{B 2} \\ {Z}_{B 2}\end{matrix} ]\end{matrix} \\ [ \begin{matrix}{X}_{B 2}^{′} \\ {Y}_{B 2}^{′} \\ {Z}_{B 2 }^{′}\end{matrix} ] = p [ \begin{matrix}{X}_{R 2} \\ {Y}_{R 2} \\ {Z}_{R 2}\end{matrix} ] + q [ \begin{matrix}{X}_{G 2} \\ {Y}_{G 2} \\ {Z}_{G 2}\end{matrix} ] + r [ \begin{matrix}{X}_{B 2} \\ {Y}_{B 2} \\ {Z}_{B 2}\end{matrix} ]\end{matrix} \} \qquad ( 4 )$$

It suffices that the relationship of Expression (5) holds for obtaining the equal brightness and chromaticity between the two screens, which merely requires to determine the correction parameters (a to r) so as to satisfy this condition.

The corrections are made in accordance with the correction parameters determined as described above, to thereby form image light. As shown in FIG. 2, the ratio between the periods of time of the ON light 12 and the OFF light 15 during the video display period of each light source is changed based on the correction parameters and PWM control is performed in the DMD chip 11, with the result that the image light subjected to correction is projected.

$$\begin{matrix}\begin{matrix}[ \begin{matrix}{X}_{R 1}^{′} \\ {Y}_{R 1}^{′} \\ {Z}_{R 1}^{′}\end{matrix} ] = [ \begin{matrix}{X}_{R 2}^{′} \\ {Y}_{R 2}^{′} \\ {Z}_{R 2}^{′}\end{matrix} ] \\ [ \begin{matrix}{X}_{G 1}^{′} \\ {Y}_{G 1}^{′} \\ {Z}_{G 1}^{′}\end{matrix} ] = [ \begin{matrix}{X}_{G 2}^{′} \\ {Y}_{G 2}^{′} \\ {Z}_{G 2}^{′}\end{matrix} ]\end{matrix} \\ [ \begin{matrix}{X}_{B 1}^{′} \\ {Y}_{B 1}^{′} \\ {Z}_{B 1}^{′}\end{matrix} ] = [ \begin{matrix}{X}_{B 2}^{′} \\ {Y}_{B 2}^{′} \\ {Z}_{B 2 }^{′}\end{matrix} ]\end{matrix} \} \qquad ( 5 )$$

While this preferred embodiment has described the case in which a multi-screen display device includes two projectors, a similar calculation to the above enables to correct a gap in brightness and a gap in chromaticity between screens even if the number of projectors, that is, the number of screens increases.

The DMD chip 11 is used as a light modulator in this preferred embodiment, which is not limited thereto as long as a function as a light modulator is provided.

While LEDs are used as light sources in this preferred embodiment, a laser or lamps may be used as light sources.

<Effects>

The multi-screen display device according to this preferred embodiment is a multi-screen display device in which screens of a plurality of projectors are combined to form one screen. Each projector includes a light source, an illumination optical system that irradiates the light output from the light source as illumination light, a light modulator that modulates the illumination light and forms image light, and the projection optical system 13 that projects the image light onto the screen 14. The multi-screen display device includes at least one spectral sensor 19 that detects changes in brightness and chromaticity of the image light in each projector.

Accordingly, the brightness and chromaticity of each light source can be detected accurately by measuring an optical spectrum per monochromatic light source with the spectral sensor 19. This enables to reduce a difference in brightness and a difference in chromaticity between screens by correcting the brightness and chromaticity of the image light even if a wavelength of the monochromatic light source changes. The spectral sensor 19 is included in the multi-screen display device, which eliminates a burden of a user of, for example, installing a spectral sensor every time corrections are made. Therefore, operability is improved compared with a conventional case.

The multi-screen display device according to this preferred embodiment is characterized in that the spectral sensor 19 is included in each projector. Accordingly, the spectral sensor 19 included for each projector enables to shorten the path of the OFF light 15 that is provided to the spectral sensor 19, which enables to simplify the configuration of the projector.

The multi-screen display device according to this preferred embodiment is characterized in that a light modulator is the DMD chip 11 and the spectral sensor 19 detects the OFF light 15 of the DMD chip 11. Accordingly, the use of the DMD chip 11 as a light modulator enables to made corrections with the use of the OFF light 15, whereby corrections can be made even while an image is being projected onto the screen 14. Therefore, it is not required to interrupt the display of a video image for corrections even if corrections are required during the display of a video image, leading to improvement of usability for a user.

### Second Preferred Embodiment

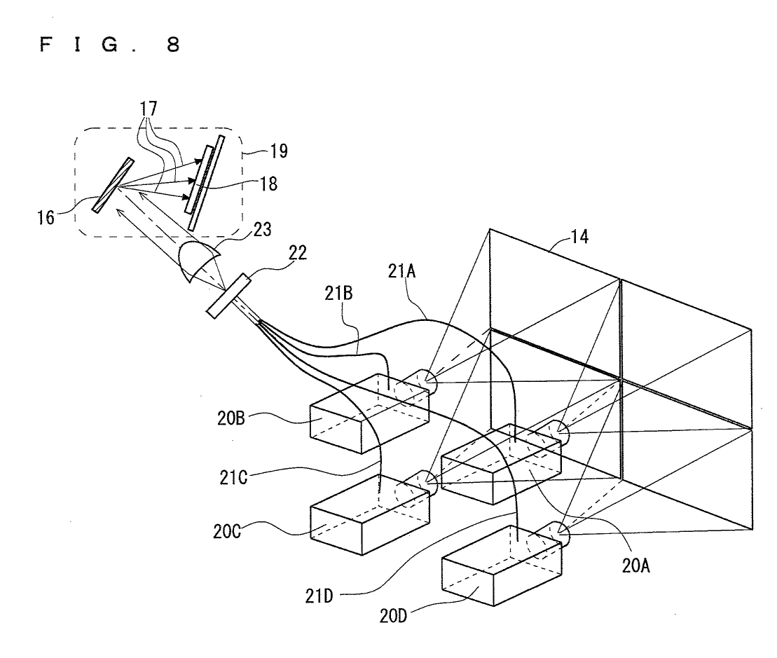

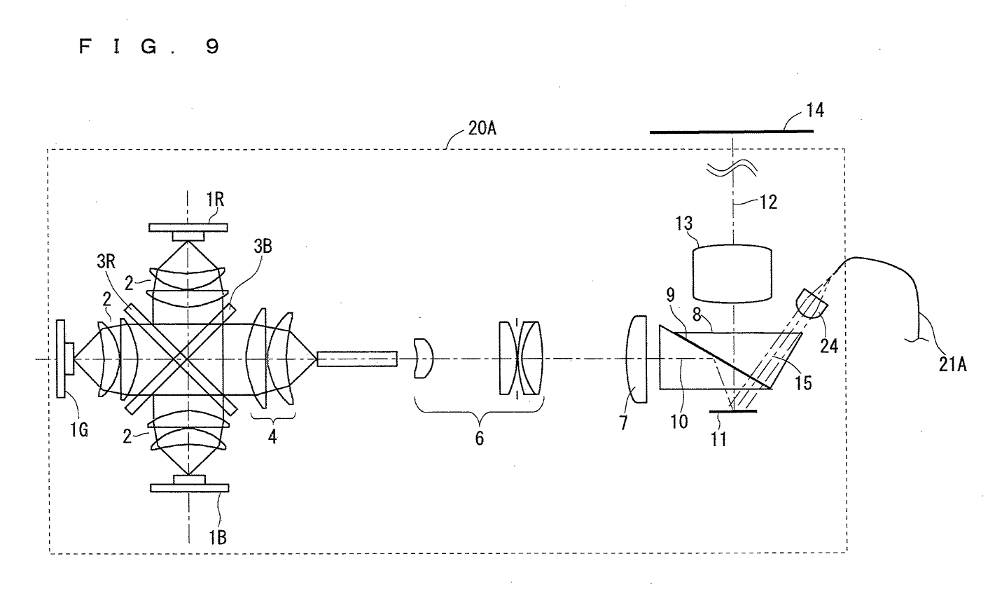

As shown in FIG. 8, a multi-screen display device according to this preferred embodiment includes four projectors 20A, 20B, 20C, and 20D, and the spectral sensor 19 included in the multi-screen display device is shared among the projectors.

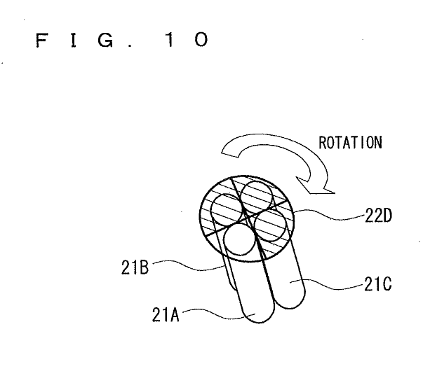

FIG. 9 shows the configuration of the projector 20A in this preferred embodiment. The configurations of the projectors 20B, 20C, and 20D are the same as that of the projector 20A. The basic configuration and operation as a video projection device of each projector are the same as those of the first preferred embodiment, which are not described here.

The OFF light 15 of the DMD chip 11 in each projector is taken out from the projector by each of optical fibers 21A, 21B, 21C, and 21D, and enters the spectral sensor 19 through a shutter 22 (described below) and a collimator lens 23 that collimates a light beam. The configuration and function of the spectral sensor 19 are the same as those of the first preferred embodiment, which are not described here.

As shown in FIG. 9, in the projector 20A, the OFF light 15 of the DMD chip 11 is condensed on an incident end of the optical fiber 21A by a condensing lens 24 and is captured by the optical fiber 21A.

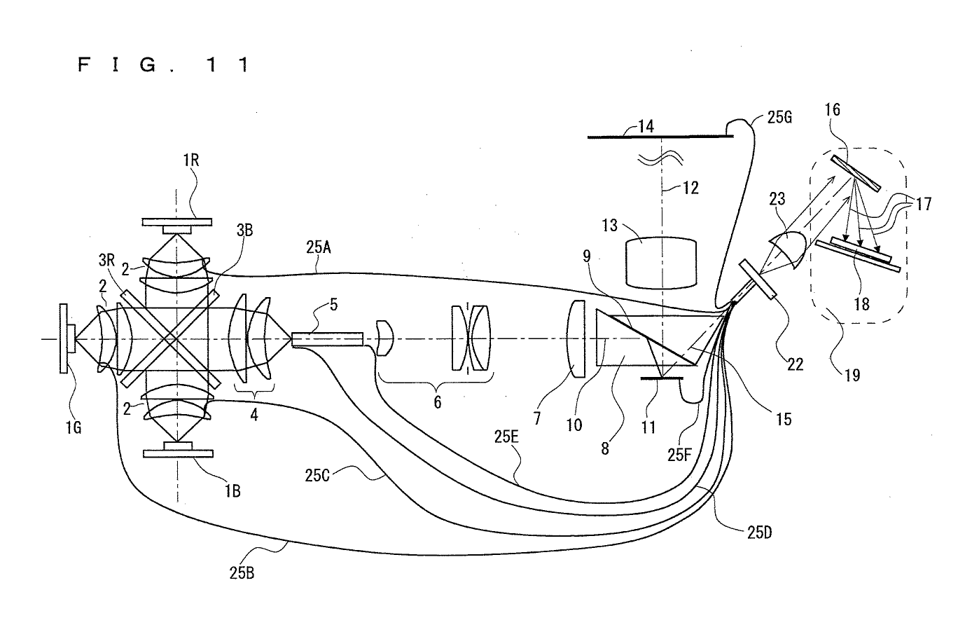

The beams of OFF light 15 of the projectors respectively captured by the optical fibers 21A, 21B, 21C, and 21D in the projectors 20A, 20B, 20C, and 20D are switched by the shutter 22 such that only a light beam to be measured by the spectral sensor 19 is allowed to pass therethrough. As shown in, for example, FIG. 10, the shutter 22 is formed of a member that has an opening for an amount of one optical fiber and is capable of selecting each of the optical fibers through rotation. The shutter 22 is sequentially switched in this manner, whereby optical spectrum data of the projectors can be obtained in order.

The multi-screen display device according to this preferred embodiment forms one screen of the screens of the four projectors, that is, four screens, which is not limited thereto as long as two or more screens are used.

<Effects>

The multi-screen display device according to this preferred embodiment is characterized in that the spectral sensor 19 is shared among the projectors 20A, 20B, 20C, and 20D and is provided solely therefor. Accordingly, in addition to the effect that the brightness and chromaticity are accurately detected and corrected with the spectral sensor 19 as described in the effects of the first preferred embodiment, the number of spectral sensors to be used can be reduced compared with the first preferred embodiment with the use of one spectral sensor 19 shared among a plurality of projectors. This enables to reduce the number of components, and thus, it is expected to reduce manufacturing cost.

### Third Preferred Embodiment

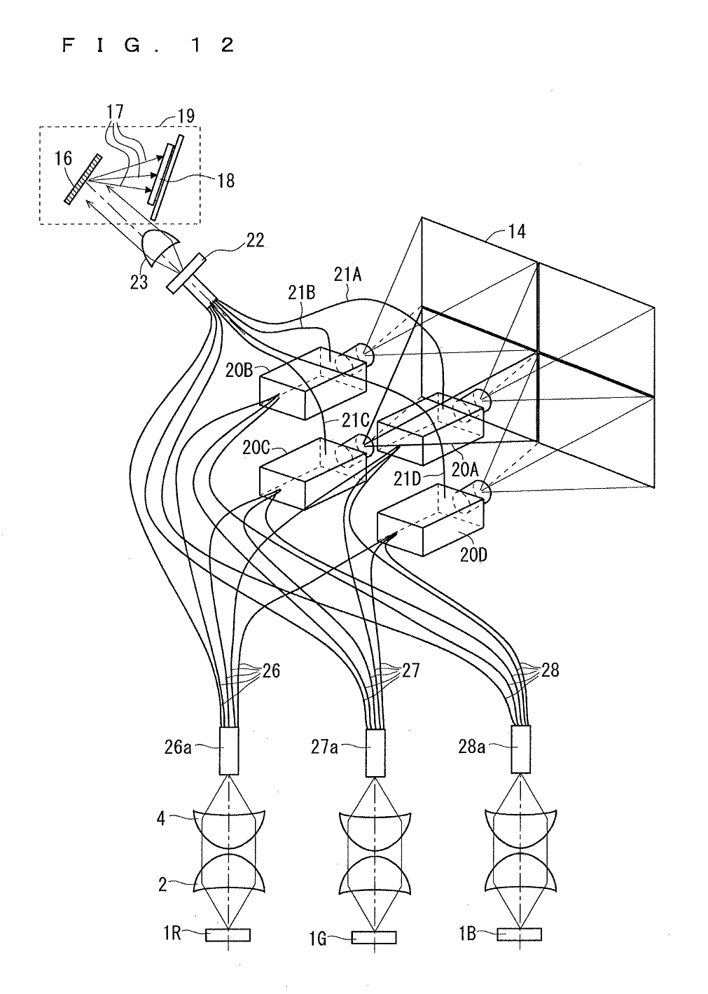

A multi-screen display device according to this preferred embodiment includes two projectors (first projector and second projector) as in the first preferred embodiment. FIG. 11 shows the configuration of the first projector. The configuration of the projector according to this preferred embodiment is different from the configuration (FIG. 1) of the projector according to the first preferred embodiment in that optical fibers are disposed as described below in the configuration of the first preferred embodiment. That is, optical fibers 25A, 25B, 25C, 25D, 25E, 25F, and 25G are disposed so as to capture the light from the red LED light source 1R, the light from the green LED light source 1G, the light from the blue LED light source 1B, the light that enters the integrator 5, the light emitted from the integrator 5, the light incident on the DMD chip 11, and the light projected onto the screen 14, respectively.

The light beams captured by the optical fibers are provided to the spectral sensor 19 together with the OFF light 15 through the shutter 22 and the collimator lens 23. Here, the shutter 22 has a similar structure to that of the shutter 22 described in the second preferred embodiment (FIG. 10). Note that the number of light beams to be provided to the shutter 22 differs from that of the second preferred embodiment. The configuration of the second projector is the same as the configuration of the first projector.

The optical spectra of the light beams of the optical fibers and the OFF light 15 can be measured sequentially by switching the shutter 22. The comparison of the measured optical spectra enables to measure the degrees of deterioration of light sources, optical components, and an optical system. While the optical spectra of the optical fibers 25A to 25F can be measured constantly, only the optical fiber 25G that captures the light projected onto the screen 14 needs to output a signal dedicated for measurement when being measured.

For example, if the initial optical spectrum of the red LED light source 1R is denoted by S_{R0}(λ) and the optical spectrum after use is denoted by S_{R}(λ), the degree of deterioration of the red LED light source 1R due to the use can be measured by Expression (6).

S_{R}(λ)/S_{R0}(λ) (6)

In a case where a value obtained by Expression (6) falls below one, an occurrence of deterioration is conceivable. Accordingly, it is possible to display maintenance information indicating, for example, replacement of light sources based on the value of Expression (6) and inform a user of the replacement.

For example, in a case of measuring the degree of deterioration of the integrator 5, if the initial optical spectrum of the light that enters the integrator 5 is denoted by S_{25D0}(λ) and the optical spectrum thereof after use is denoted by S_{25D}(λ), the attenuation of the light that enters the integrator 5 is obtained by Expression (7).

S_{25D}(λ)/S_{25D0}(λ) (7)

If the initial optical spectrum of the exit light from the integrator 5 is denoted by S_{25E0}(λ) and the optical spectrum thereof after use is denoted by S_{25E}(λ), the attenuation of the exit light from the integrator 5 is obtained by Expression (8).

S_{25E}(λ)/S_{25E0}(λ) (8)

The ratio between attenuation rates of Expression (7) and Expression (8) is obtained as shown in Expression (9), whereby the degree of deterioration of the integrator 5 can be obtained.

$$\frac{{S}_{25 E} ( λ ) / {S}_{25 E 0} ( λ )}{{S}_{25 E} ( λ ) / {S}_{25 D 0} ( λ )} \qquad ( 9 )$$

If a value obtained by Expression (9) is one, it is shown that the integrator 5 has not deteriorated. Meanwhile, a value below one means that the integrator 5 has deteriorated. The timings of, for example, replacing and cleaning the integrator 5 can be judged from the degree of deterioration.

The spectra of light are measured at appropriate positions, that is, upstream and downstream of a light source, an illumination optical system, and the like and upstream and downstream of optical equipment such as an integrator, whereby it is possible to check the degrees of deterioration of the optical system and optical components.

<Effects>

The multi-screen display device according to this preferred embodiment is characterized in that some of the light from the light source, the light from the illumination optical system, the light from the light modulator, and the light from the projection optical system are provided to the spectral sensor 19 and are compared to each other. Therefore, in addition to the effects described in the first preferred embodiment, it is possible to detect the deterioration of the light source, optical components, and optical system with the use of the spectral sensor 19.

### Fourth Preferred Embodiment

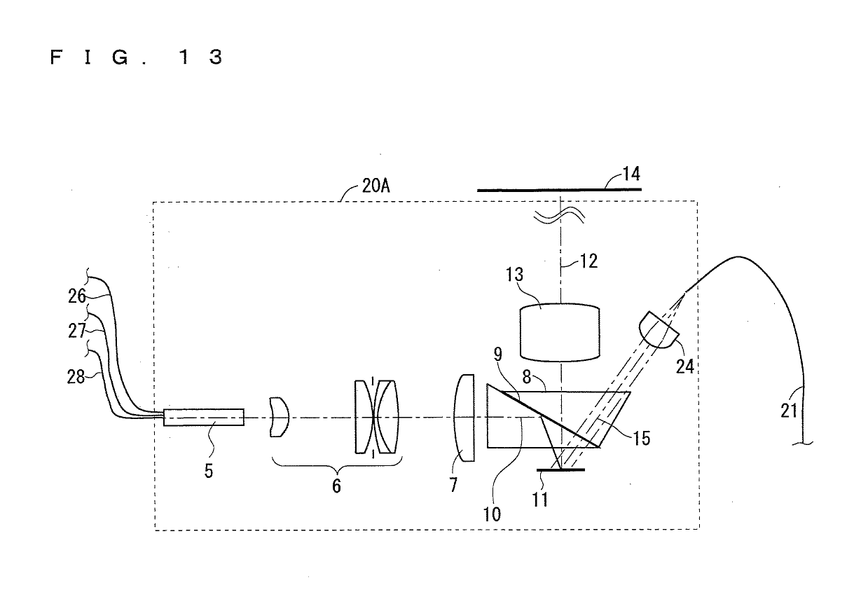

FIG. 12 shows the configuration of a multi-screen display device according to this preferred embodiment. This preferred embodiment is different from the second preferred embodiment (FIG. 8) in that the light sources, that is, the red LED light source 1R, the green LED light source 1G, and the blue LED light source 1B are shared among the projectors 20A, 20B, 20C, and 20D. The other is the same as that of the second preferred embodiment, which is not described here.

With reference to FIG. 12, the light beams of the respective colors emitted from the red LED light source 1R, the green LED light source 1G, and the blue LED light source 1B are condensed on fiber ends of a red LED light source optical fiber flux 26a, a green LED light source optical fiber flux 27a, and a blue LED light source optical fiber flux 28a, respectively, through the collimator lenses 2 and the condensing lenses 4. Optical fibers 26, 27, and 28 in which light beams of the respective colors are captured by being allocated by the optical fiber fluxes 26a, 27a, and 28a are connected to the projectors 20A, 20B, 20C, and 20D and the shutter 22 of the spectral sensor 19, as shown in FIG. 12.

FIG. 13 shows the configuration of the projector 20A. This preferred embodiment is different from the second preferred embodiment (FIG. 9) in that the light sources of the projector 20A are not included in the projector 20A. The optical fibers 26, 27, and 28 that transmit the light beams of the respective colors from the light sources are connected to the entrance surface of the integrator 5. The other is the same as that of the second preferred embodiment, which is not described here. The configurations of the projectors 20B, 20C, and 20D are also the same as that of the projector 20A.

The optical fibers 26, 27, and 28 from the respective light sources are also connected to the spectral sensor 19, whereby it is possible to check, for example, the deterioration of a light source as in the third preferred embodiment.

In this preferred embodiment, one light source red LED light source 1R, one green LED light source 1G, and one blue LED light source 1B may not be allocated for each of the projectors 20A, 20B, 20C, and 20D. Alternatively, a plurality of the above-mentioned light sources may be allocated to each of the projectors 20A, 20B, 20C, and 20D as long as they are allocated evenly.

<Effects>

The multi-screen display device according to this preferred embodiment is characterized in that the light sources shared among the projectors 20A, 20B, 20C, and 20D are included in place of the light sources provided for every projectors as in the second preferred embodiment. Accordingly, in addition to the effects described in the second preferred embodiment, in a case of, for example, high luminous intensity of a light source, it is possible to improve the use efficiency of light sources by sharing the light sources among the projectors. In addition, it is possible to reduce the number of light sources to be used through sharing, and a reduction in manufacturing cost can be expected.

While the invention has been shown and described in detail, the foregoing description is in all aspects illustrative and not restrictive. It is therefore understood that numerous modifications and variations can be devised without departing from the scope of the invention.

What is claimed is:

1. A multi-screen display device in which screens of a plurality of projectors are combined to form one screen,
each of said projectors including:
a light source;
an illumination optical system that irradiates the light output from said light source as illumination light;
a light modulator that modulates said illumination light and forms image light; and
a projection optical system that projects said image light onto a screen,
said multi-screen display device including at least one spectral sensor that detects changes in brightness and chromaticity of said image light in each of said projectors.

2. The multi-screen display device according to claim 1, wherein said spectral sensor is included in each of said projectors.

3. The multi-screen display device according to claim 1, wherein said spectral sensor is shared among said projectors, said spectral sensor being provided solely therefor.

4. The multi-screen display device according to claim 1, wherein said light modulator is a DMD chip, and said spectral sensor detects OFF light of said DMD chip.

5. The multi-screen display device according to claim 2, wherein said light modulator is a DMD chip, and said spectral sensor detects OFF light of said DMD chip.

6. The multi-screen display device according to claim 3, wherein said light modulator is a DMD chip, and said spectral sensor detects OFF light of said DMD chip.

7. The multi-screen display device according to claim 1, wherein some of the light from said light source, the light from said illumination optical system, the light from said light modulator, and the light from said projection optical system are provided to said spectral sensor and are compared with each other.

8. The multi-screen display device according to claim 2, wherein some of the light from said light source, the light from said illumination optical system, the light from said light modulator, and the light from said projection optical system are provided to said spectral sensor and are compared with each other.

9. The multi-screen display device according to claim 3, wherein some of the light from said light source, the light from said illumination optical system, the light from said light modulator, and the light from said projection optical system are provided to said spectral sensor and are compared with each other.

10. The multi-screen display device according to claim 4, wherein some of the light from said light source, the light from said illumination optical system, the light from said light modulator, and the light from said projection optical system are provided to said spectral sensor and are compared with each other.

11. The multi-screen display device according to claim 1, wherein a light source shared among said projectors is included in place of said light source included in each of said projectors.

12. The multi-screen display device according to claim 2, wherein a light source shared among said projectors is included in place of said light source included in each of said projectors.

13. The multi-screen display device according to claim 3, wherein a light source shared among said projectors is included in place of said light source included in each of said projectors.

14. The multi-screen display device according to claim 4, wherein a light source shared among said projectors is included in place of said light source included in each of said projectors.
